(19) United States
(12) Patent Application Publication
(10) Pub. No.: US 2026/0135208 A1
(43) Pub. Date: May 14, 2026

(54) Battery Case and Battery Cell

(71) Applicant: SK On Co., Ltd., Seoul (KR)

(72) Inventors: Hyun Seok KIM, Daejeon (KR); Mi So RHO, Daejeon (KR); Dong Hyee LEE, Daejeon (KR)

(21) Appl. No.: 19/363,804

(22) Filed: Oct. 21, 2025

(30) Foreign Application Priority Data
Nov. 11, 2024 (KR) 10-2024-0159123

(51) Int. Cl. H01M 50/15; H01M 50/103; H01M 50/107; H01M 50/152; H01M 50/169

(52) U.S. Cl. CPC H01M 50/15; H01M 50/103; H01M 50/107; H01M 50/152; H01M 50/169

(57) ABSTRACT

The present disclosure relates to a battery case and a battery cell. A battery case according to an embodiment may include: a case body having an opening for receiving an electrode assembly; a cap plate inserted into the opening; and a protrusion portion into which the cap plate is inserted, the protrusion portion protruding outward relative to other regions of the case body.

### CROSS-REFERENCE TO RELATED PATENT APPLICATION

The present application claims priority under 35 U.S.C. § 119(a) to Korean patent application number 10-2024-0159123 filed on Nov. 11, 2024, in the Korean Intellectual Property Office, the entire disclosure of which is incorporated by reference herein.

### BACKGROUND OF THE INVENTION

### 1. Field

The present disclosure relates to a battery case and a battery cell, and more particularly, to a battery case and a battery cell with enhanced safety.

### 2. Description of the Related Art

A secondary battery is a type of battery that converts electrical energy into chemical energy for storage, allowing it to be recharged and reused multiple times through charging and discharging cycles. Due to its economic and environmentally friendly characteristics, secondary batteries are widely and extensively used across various industries. In particular, lithium secondary batteries are widely utilized in numerous industrial applications, including portable electronic devices that require high energy density.

The operating principle of a lithium secondary battery is based on electrochemical redox (reduction-oxidation) reactions. That is, electricity is generated by the movement of lithium ions, and the reverse process corresponds to charging. In a lithium secondary battery, the process in which lithium ions move from the anode (negative electrode) through the electrolyte and separator to the cathode (positive electrode) is referred to as discharging. The reverse of this process is called charging.

A secondary battery is manufactured by assembling multiple components, and in particular, an electrode assembly and an electrolyte are housed within a case. The sealing performance of the case is a critical factor that can significantly affect the performance of the secondary battery, and thus extensive research is being conducted to improve it.

### SUMMARY OF THE INVENTION

An embodiment of the present disclosure provides a battery case and a battery cell with excellent stability.

An embodiment of the present disclosure provides a battery case and a battery cell with excellent sealing performance.

An embodiment of the present disclosure provides a battery case and a battery cell in which electrolyte leakage does not occur.

A battery case and a battery cell according to the present disclosure may be widely applied in the field of green technology such as electric vehicles, battery charging stations, energy storage systems (ESS), and other battery-based photovoltaics and wind power. In addition, the battery inspection apparatus according to the present disclosure may be used for eco-friendly mobility, including electric vehicles and hybrid vehicles, to prevent climate change by restraining air pollution and greenhouse gas emissions.

As a technical means to achieve the technical objects, an embodiment of the present disclosure provides a battery case comprising: a case body having an opening for receiving an electrode assembly; a cap plate inserted into the opening; and a protrusion portion into which the cap plate is inserted, the protrusion portion protruding outward relative to other regions of the case body.

In one embodiment, a width W2 of the cap plate may be greater than a width W1 of the opening.

In one embodiment, the protrusion portion may protrude by a difference W2−W1 between the width W2 of the cap plate and the width W1 of the opening.

In one embodiment, a thickness of the case body at regions other than the protrusion portion may be equal to a thickness of the case body at the protrusion portion.

In one embodiment, the cap plate may include an insertion region having a width smaller than the width of the opening.

In one embodiment, the protrusion portion may be formed in a longitudinal direction and/or a widthwise direction of the case body.

In one embodiment, the case body may be prismatic or cylindrical.

In one embodiment, the case body may be cylindrical, and an outer diameter of the cap plate may be greater than an inner diameter of the opening.

An embodiment of the present disclosure provides a battery cell comprising: a case body having an opening for receiving an electrode assembly; an electrode assembly accommodated in the case body; a cap plate inserted into the opening; and a protrusion portion into which the cap plate is inserted, the protrusion portion protruding outward relative to other regions of the case body.

In one embodiment, a width W2 of the cap plate may be greater than a width W1 of the opening.

In one embodiment, a thickness of the case body at regions other than the protrusion portion may be equal to a thickness of the case body at the protrusion portion.

In one embodiment, the case body and the cap plate may be sealed by welding.

According to an embodiment of the disclosure as described above, a battery case and a battery cell with excellent stability.

An embodiment of the present disclosure can provide a battery case and a battery cell with excellent sealing performance.

An embodiment of the present disclosure can provide a battery case and a battery cell in which electrolyte leakage does not occur.

### BRIEF DESCRIPTION OF THE DRAWINGS

FIG. 1 is a perspective view schematically illustrating a battery case according to one embodiment of the present disclosure.

FIG. 2 is a diagram schematically illustrating a portion of a battery case according to one embodiment of the present disclosure.

FIGS. 3, 4A and 4B are drawings schematically illustrating the assembly process of a battery cell according to one embodiment of the present disclosure.

FIGS. 5A and 5B are a diagram for comparison with an assembly process of a battery cell according to one embodiment of the present disclosure.

FIG. 6 is a schematic illustration of a battery cell according to one embodiment of the present disclosure.

### DETAILED DESCRIPTION

Hereinafter, the present disclosure will be described in detail with reference to the accompanying drawings. However, these are exemplary only and do not limit the present disclosure to the specific embodiments illustrated.

Throughout the specification, certain terms used herein are for convenience of description only and are not intended to be limiting to the embodiments shown.

For example, expressions such as “identical” and “identical to” refer not only to strictly identical states, but also to states where tolerances, or differences in the degree to which the same functionality is achieved, exist.

For example, expressions that indicate relative or absolute placement, such as “in a direction,” “along a direction,” “side by side,” “perpendicular,” “centered,” “concentric,” or “coaxial,” not only strictly indicate such placement, but also indicate a tolerance, or a state of relative displacement by an angle or distance that results in the same function.

For the purposes of describing the present disclosure, the following discussion will be based on a spatial Cartesian coordinate system along an X-axis, a Y-axis, and a Z-axis that are orthogonal to each other. Each axial direction (X-axis, Y-axis, Z-axis) refers to the two directions in which the respective axis extends.

References herein to X, Y, and Z directions are for purposes of clarity of the present disclosure, although each direction may be defined differently depending on where the reference is placed.

The use of terms such as “first,” “second,” “third,” and the like preceding the components referred to herein is intended to avoid confusion as to the components to which they refer and is not intended to indicate any order, importance, or master-servant relationship among the components. For example, it is possible to practice an invention comprising only a second component without a first component.

The terminology used in the present disclosure is for the description of specific embodiments and is not intended to limit the claims. As used in the description of the embodiments and in the appended claims, singular forms are intended to include plural forms unless the context clearly indicates otherwise.

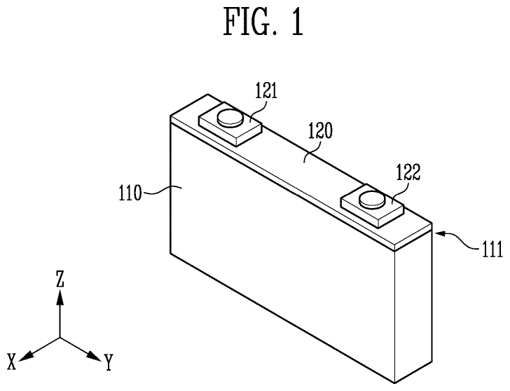

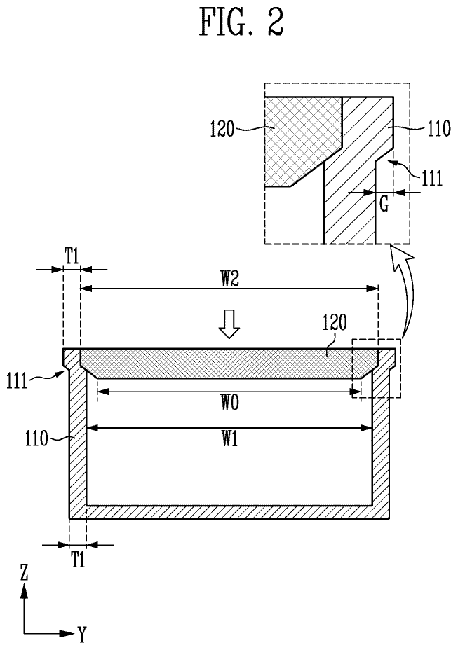

FIG. 1 is a perspective view schematically illustrating a battery case according to one embodiment of the present disclosure. FIG. 2 is a diagram schematically illustrating a portion of a battery case according to one embodiment of the present disclosure.

Referring to FIGS. 1 and 2, a battery case according to one embodiment of the present disclosure comprises a case body 110 having an opening for receiving an electrode assembly; a cap plate 120 inserted into the opening; and a protrusion portion 111 into which the cap plate is inserted, the protrusion portion 111 protruding outward relative to other regions of the case body.

The battery cell according to one embodiment of the present disclosure can be understood as having the electrode assembly 130 housed within a battery case. While FIGS. 1 and 2 illustrate a prismatic battery case, it may be cylindrical, prismatic, or the like, without limitation.

Hereinafter, the battery case and the battery cell will be described together.

The battery cell may further include an electrolyte. The electrolyte may serve as a medium for transferring ions or current between the cathode and the anode of the electrode assembly 130.

In one embodiment, the battery cell 100 may be a secondary battery capable of multiple charge and discharge cycles. For example, the secondary battery may be one of a lithium cobalt battery, lithium high-nickel battery, lithium iron phosphate battery, lithium-ion battery, lithium polymer battery, lithium-sulfur battery, nickel-metal hydride battery, nickel-cadmium battery, sodium battery, or all-solid-state battery, but is not limited thereto and may be modified into various types of secondary batteries.

The electrode assembly 130 may include an electrode and a separator. In one embodiment, the electrode assembly 130 may include a first electrode and a second electrode, and a separator may be disposed between the first and second electrodes.

In the embodiment, the electrode assembly 130 may be in the form of a plate, rectangular, or a wound roll.

In one embodiment, the battery case may include electrode terminals 121, 122. In one embodiment, the electrode terminals 121, 122 may be formed on the cap plate 120.

The electrode terminals 121, 122 may be electrically connected to the electrode assembly 130, and the electrode terminals 121, 122 may be electrically connected to an external device. That is, current may flow to the external device through the electrode terminals 121, 122.

The first electrode and the second electrode of the electrode assembly 130 may each include an electrode lead 131, 132, and the electrode leads 131, 132 may be electrically connected to the electrode terminals 121, 122.

According to one embodiment, a width W2 of the cap plate 120 may be greater than a width W1 of the opening 110A of the case body 110. The width W2 of the cap plate 120 may be based on an outer side of the cap plate 120.

In one embodiment, the width W2 of the region of the cap plate 120 inserted into the opening 110A of the case body 110 may be greater than the width W1 of the opening 110A of the case body 110. The width W1 of the opening 110A of the case body 110 may be based on the inner side of the case body 110, i.e., the inner wall.

The protrusion portion 111 may be formed in a region of the opening 110A of the case body 110 where the cap plate 120 is inserted. This is due to the width of the cap plate 120 being greater than the width of the opening of the case body 110. As the cap plate 120 is inserted into the case body 110, a region of the opening of the case body may be expanded by the width of the cap plate 120. At this time, the region of the opening of the case body 110 into which the cap plate is inserted may be expanded in width by an amount corresponding to the width of the cap plate, whereas the region of the opening into which the cap plate is not inserted may remain unexpanded in width.

In one embodiment, the term “width” refers to the size of the cap plate, and depending on the shape of the cap plate, it may refer to the length, width, or diameter. In one embodiment, when the cap plate is prismatic, the width may refer to the length or width of the cap plate. In addition, when the cap plate is circular, the width may refer to the diameter.

In one embodiment, the difference W2−W1 between the widths of the cap plate 120 and the opening 110A of the case body 110 may be 0.4 to 0.8. Alternatively, the difference W2−W1 between the widths of the cap plate 120 and the opening 110A of the case body may be 0.2 to 0.4.

In one embodiment, the width W1 of the opening 110A of the case body may range from 28 to 32 mm, and more specifically, from 29 to 31 mm, or from 29.6 to 30.4 mm, or from 29.8 to 30.2 mm.

In one embodiment, the width W2 of the cap plate 120 may range from 28 to 32 mm, and more specifically, from 29 to 31 mm, or from 29.6 to 30.4 mm, or from 29.8 to 30.2 mm.

In one embodiment, the width W1 of the opening 110A of the case body may be from 29.8 to 30.2 mm, and the width W2 of the cap plate 120 may be from 30.2 to 30.6 mm.

In one embodiment, the protrusion portion 111 may protrude outwardly from the case body by a difference W2−W1 between the width W2 of the cap plate and the width W1 of the opening.

The space in the case body where the electrode assembly is housed may be defined as the inner side, and the opposite direction may be defined as the outer side. That is, the outer surface of the case body may be understood as the outer side.

Referring to FIG. 2, the region of the case body 110 into which the cap plate 120 is inserted may protrude outward by a predetermined distance G relative to other regions of the case body 110, thereby forming the protrusion portion 111.

In one embodiment, the thickness T1 of the case body at regions other than the protrusion portion 111 is equal to a thickness T1 of the case body at the protrusion portion 111.

In one embodiment, the protrusion portion 111 may be formed in a longitudinal direction and/or a widthwise direction of the case body 110.

In one embodiment, when the battery case is prismatic, the protrusion portions 111 may be formed on both sides in the longitudinal direction (y-direction) of the opening 110A of the case body 110. The cap plate having a greater length than the length of the opening of the case body may be inserted into the case body to form the protrusion portion in a region of the opening.

In one embodiment, when the battery case is prismatic, the protrusion portions 111 may be formed on both sides in the widthwise direction (x-direction) of the opening 110A of the case body 110. The cap plate having a greater width than the width of the opening of the case body may be inserted into the case body to form the protrusion portion in a region of the opening.

In one embodiment, when the battery case is prismatic, the protrusion portions 111 may be formed in both the longitudinal direction (y-direction) and the widthwise direction (x-direction) of the opening 110A of the case body 110.

In one embodiment, the cap plate 120 includes an insertion region having a width W0 smaller than the width W1 of the opening 110A of the case body.

The width W0 of the insertion region of the cap plate 120 may be from 25 to 28 mm.

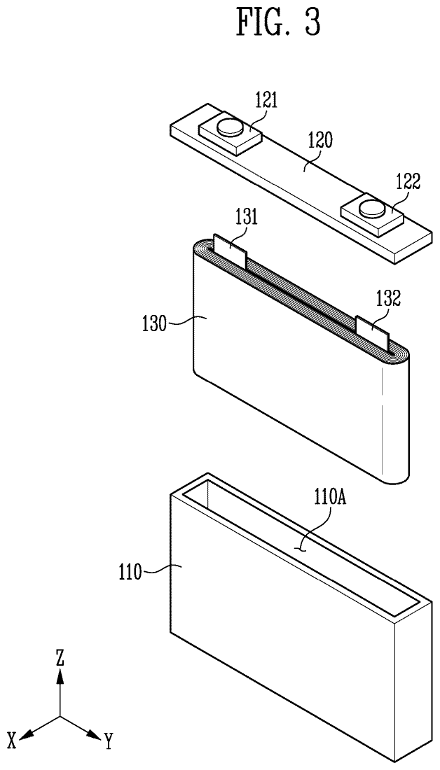

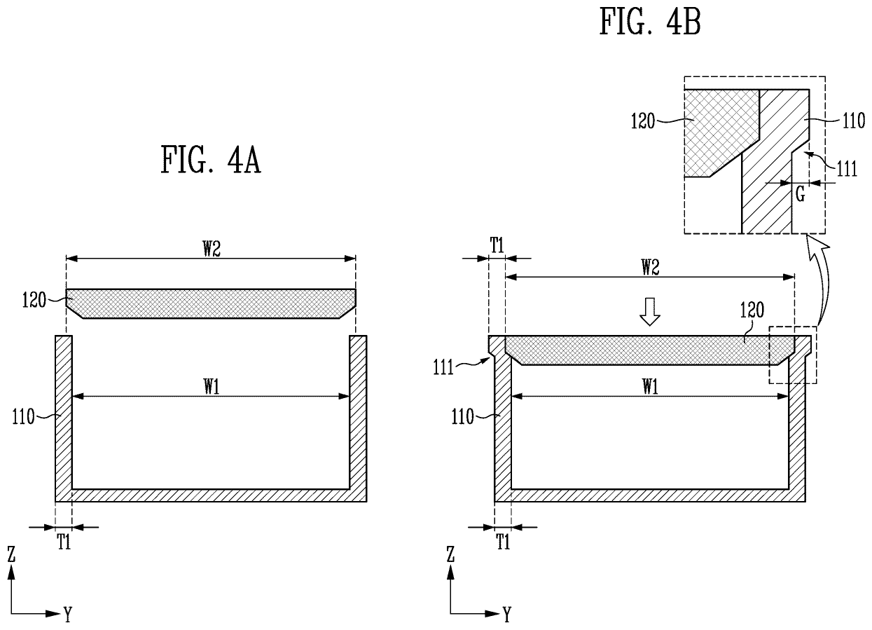

FIGS. 3, 4A and 4B are drawings schematically illustrating the assembly process of a battery cell according to one embodiment of the present disclosure. Hereinafter, an assembly process of a battery case and a battery cell according to an embodiment of the present disclosure will be described. Through this, the structure of the battery case and the battery cell according to an embodiment of the present disclosure can be more clearly understood.

In one embodiment, after the electrode assembly 130 is accommodated inside the case body 110, the cap plate 120 may be inserted into the case body 110. The electrode assembly 130 may be accommodated through the opening 110A of the case body 110. The shape of the opening 110A is not particularly limited, as long as it allows the electrode assembly 130 to pass through. The shape of the cap plate 120 may correspond to the shape of the opening 110A.

According to one embodiment of the present disclosure, the width W2 of the cap plate 120 may be greater than the width W1 of the opening 110A of the case body 110.

The width W2 of the cap plate 120 may be based on the outer side of the cap plate 120. The width of the portion of the cap plate 120 that is inserted into the opening 110A of the case body 110 may be greater than the width W1 of the opening 110A of the case body 110.

The width W1 of the opening 110A of the case body 110 may be based on the inner side of the case body 110, that is, the inner wall.

In one embodiment, the difference W2−W1 between the widths of the cap plate 120 and the opening 110A of the case body 110 may be 0.4 to 0.8 mm. Alternatively, the difference W2−W1 between the widths of the cap plate 120 and the opening 110A of the case body may be 0.2 to 0.4 mm.

In one embodiment, the width W1 of the opening 110A of the case body may be 28 to 32 mm, specifically 29 to 31 mm, 29.6 to 30.4 mm, or 29.8 to 30.2 mm.

In one embodiment, the width W2 of the cap plate 120 may be 28 to 32 mm, specifically 29 to 31 mm, 29.6 to 30.4 mm, or 29.8 to 30.2 mm.

In one embodiment, the width W1 of the opening 110A of the case body may be 29.8 to 30.2 mm, and the width W2 of the cap plate 120 may be 30.2 to 30.6 mm.

In one embodiment, the cap plate 120 includes an insertion region having a width W0 smaller than the width W1 of the opening 110A of the case body.

The width W0 of the insertion region of the cap plate 120 may be from 25 to 28 mm.

According to one embodiment, the cap plate 120 may be inserted into the case body 110 by a press-fitting method.

In the present disclosure, the press-fitting method refers to a method in which a physical force is applied to insert an object into a space smaller than the object being inserted. That is, in the present disclosure, it may refer to a method of inserting a cap plate 120 having a greater width than the opening 110A into the opening 110A.

As described above, since the width W2 of the cap plate is greater than the width W1 of the opening 110A of the case body, the cap plate 120 may not be directly inserted into the case body 110.

Therefore, the cap plate 120 may be inserted into the opening 110A of the case body by the press-fitting method. In other words, the cap plate 120 may be placed on the opening 110A, and a predetermined pressure may be applied to the cap plate 120. Then, the opening 110A of the case body 110 may slightly expand, allowing the cap plate 120 to be inserted. Accordingly, the case body 110 and the cap plate 120 may be in complete close contact without any gap.

In one embodiment, the case body 110 may include various materials such as iron, aluminum, an alloy of these metals, plastic, ceramic, or carbon.

In one embodiment, the case body 110 may be carbon steel with a plating layer of Ni or Sn on the surface. In another embodiment, the case body 110 may be hypoeutectoid steel containing no more than 0.8 wt % carbon. Alternatively, it may be stainless steel containing Cr.

In one embodiment, the portion of the case body 110 into which the cap plate 120 is inserted may protrude outward from the case body 110.

In one embodiment, the cap plate 120 includes the insertion region having a width W0 smaller than the width W1 of the opening 110A of the case body. After first inserting the insertion region into the opening 110A, pressure can be applied to easily press-fit the portion of the cap plate 120 with the larger width W1 into the opening 110A.

In the present disclosure, the space in which the electrode assembly is accommodated is defined as the inner side, and the opposite direction may be defined as the outer side. That is, the outer surface of the battery case may be understood as the outer side.

Referring to FIGS. 4A and 4B, the portion of the case body 110 into which the cap plate 120 is inserted may protrude a predetermined distance G more outward than other regions of the case body 110, forming the protrusion portion 111.

In one embodiment, the protrusion portion 111 relative to the outer surface of the battery case may protrude by a difference W2−W1 between the width W2 of the cap plate and the width W1 of the opening.

In one embodiment, the thickness T1 of the case body may not change during the cap plate 120 insertion process. The thickness T1 of the case body may remain unchanged during the cap plate 120 insertion, while the case body 120 may expand outward.

That is, the thickness T1 of the case body at the protrusion portion 111 may be the same as the thickness T1 in other areas of the case body.

In one embodiment, if the battery case is prismatic, the protrusion portions 111 may be formed on both sides of the opening 110A of the case body 110 in the longitudinal direction (y-direction).

In one embodiment, if the battery case is prismatic, the protrusion portions 111 may be formed on both sides of the opening 110A of the case body 110 in the width direction (x-direction).

In one embodiment, if the battery case is prismatic, the protrusion portions 111 may be formed on both the longitudinal (y-direction) and width (x-direction) sides of the opening 110A of the case body 110.

When the cap plate 120 is inserted into the case body 110, the case body 110 and the cap plate 120 may be sealed together to seal the case body 110.

The method of sealing the case body 110 and the cap plate 120 is not particularly limited and may be performed, for example, by welding. The welding method may be ultrasonic welding or laser welding.

In one embodiment, the case body 110 and the cap plate 120 may be in complete close contact without any gap, enabling excellent weldability. Since the cap plate 120, which is larger than the opening 110A of the case body 110, is inserted by the press-fitting method, the case body 110 and the cap plate 120 may be in a tightly adhered state, thereby reducing the defect rate during laser welding.

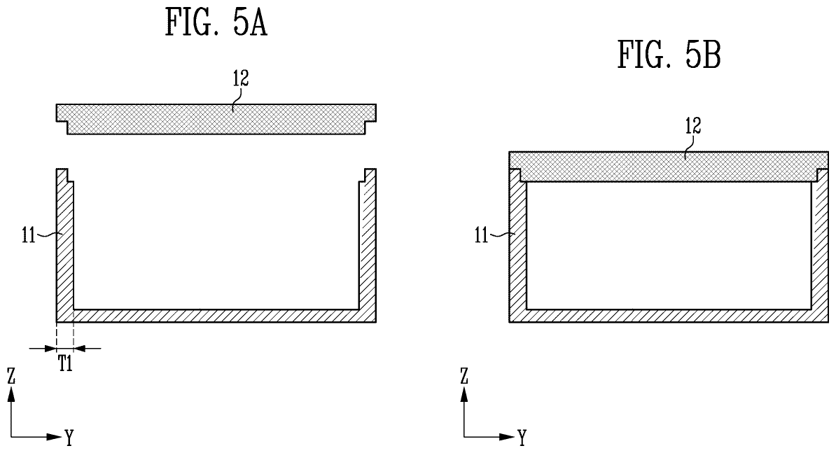

FIGS. 5A and 5B are a diagram for comparison with an assembly process of a battery cell according to one embodiment of the present disclosure.

As shown in FIGS. 5A and 5B, the cap plate 12 may be inserted into the case body 11. A step structure may be formed on the inner wall of the case body 11 to receive the cap plate 12. Due to this step structure, the adhesion between the case body 11 and the cap plate 12 may not be strong. During production of the case body 11 and the cap plate 12, tolerances may occur, and a gap may still exist between the case body 11 and the cap plate 12. In addition, the area of the cap plate 12 that joins the step structure of the case body 11 may not be welded, leading to reduced sealing performance of the case body.

In contrast, according to one embodiment of the present disclosure, the cap plate and the case body 110 may be in complete contact without any gap, resulting in superior sealing performance through welding.

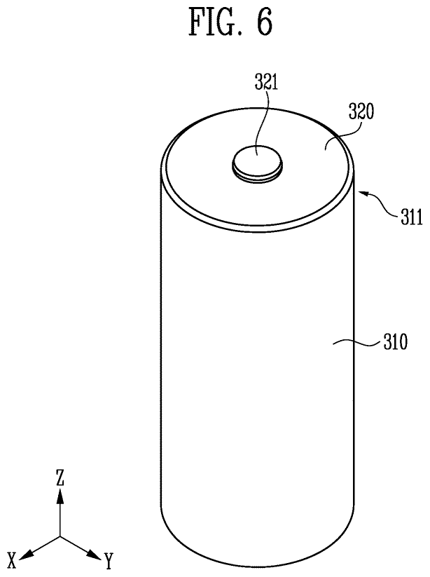

FIG. 6 is a schematic illustration of a battery cell according to one embodiment of the present disclosure.

Referring to FIG. 6, the battery cell according to one embodiment may be cylindrical.

However, this is only one embodiment, and battery cells can be shaped into a variety of shapes, such as prismatic, hexahedral, etc.

The battery cell may comprise a case body 310 having an opening for receiving an electrode assembly; an electrode assembly accommodated in the case body 310; a cap plate 320 inserted into the opening; and a protrusion portion into which the cap plate is inserted, the protrusion portion 311 protruding outward relative to other regions of the case body.

A battery cell according to one embodiment of the present disclosure may be understood as having an electrode assembly accommodated within the battery case. The electrode assembly may be in a wound roll form.

Compared with FIGS. 1 and 2, which illustrate prismatic battery cells, FIG. 6 illustrates a cylindrical battery cell.

In one embodiment, the battery cell may include an electrode terminal 321. In one embodiment, the electrode terminal 321 may be formed on the cap plate 320. Alternatively, the electrode terminal 321 may be formed on a surface opposite the cap plate 320.

The electrode assembly may include a first electrode and a second electrode, with a separator disposed between the first and second electrodes. The first and second electrodes of the electrode assembly may each include an electrode lead, which may be electrically connected to the electrode terminal 321.

In one embodiment, the width W2 of the cap plate 320 may be greater than the width W1 of the opening of the case body 310.

As described above, the width refers to the size of the cap plate and may indicate the length, width, or diameter depending on the shape of the cap plate. In one embodiment, if the cap plate is prismatic, the width may refer to the length or width of the cap plate. In another embodiment, if the cap plate is circular, the width may refer to the diameter.

The width W2 of the cap plate 320 may be based on the outer diameter of the cap plate 320.

In one embodiment, the width of the portion of the cap plate 320 inserted into the opening of the case body 310 may be greater than the width of the opening of the case body 310. The width of the opening of the case body 310 may be based on the inner diameter of the case body 310.

If the battery cell is cylindrical, the cap plate 320 and the case body may be circular, and the width may refer to a diameter. In one embodiment, an outer diameter of the cap plate 320 may be greater than an inner diameter of the opening.

In one embodiment, the difference W2−W1 between the widths of the cap plate 320 and the opening of the case body 310 may be 0.4 to 0.8. Alternatively, the difference W2−W1 between the widths of the cap plate 320 and the opening of the case body may be 0.2 to 0.4.

In one embodiment, the protrusion portion 311 may protrude outwardly from the case body 310 by the difference W2−W1 between the width W2 of the cap plate and the width W1 of the opening. The cap plate having an outer diameter greater than an inner diameter of the opening of the case body 310 can be inserted into the case body to form the protrusion portion in an one region of the opening of the case body.

In one embodiment, the thickness T1 of the case body at regions other than the protrusion portion is equal to a thickness T1 of the case body at the protrusion portion 311.

In one embodiment, the cap plate 320 includes an insertion region having a width smaller than the width of the opening of the case body.

The battery case and battery cell according to one embodiment of the present disclosure exhibit excellent adhesion between the case body and the cap plate, resulting in superior weldability. As a result, the sealing performance of the battery case is excellent, preventing leakage of the electrolyte and improving stability.

The present disclosure may be implemented in various modified forms, and the scope of the rights is not limited to the embodiments described above. Therefore, modified embodiments that include the elements recited in the claims of the present disclosure shall be considered to fall within the scope of rights of the present disclosure.

What is claimed is:

1. A battery case comprising:
a case body having an opening for receiving an electrode assembly;
a cap plate inserted into the opening; and
a protrusion portion into which the cap plate is inserted, the protrusion portion protruding outward relative to other regions of the case body.

2. The battery case according to claim 1, wherein a width W2 of the cap plate is greater than a width W1 of the opening.

3. The battery case according to claim 1, wherein the protrusion portion protrudes by a difference W2−W1 between the width W2 of the cap plate and the width W1 of the opening.

4. The battery case according to claim 1,
wherein a thickness of the case body at regions other than the protrusion portion is equal to a thickness of the case body at the protrusion portion.

5. The battery case according to claim 1, wherein the cap plate includes an insertion region having a width smaller than the width of the opening.

6. The battery case according to claim 1, wherein the protrusion portion is formed in a longitudinal direction and/or a widthwise direction of the case body.

7. The battery case according to claim 1, wherein the case body is prismatic or cylindrical.

8. The battery case according to claim 1, wherein the case body is cylindrical, and an outer diameter of the cap plate is greater than an inner diameter of the opening.

9. A battery cell comprising:
a case body having an opening for receiving an electrode assembly;
an electrode assembly accommodated in the case body;
a cap plate inserted into the opening; and
a protrusion portion into which the cap plate is inserted, the protrusion portion protruding outward relative to other regions of the case body.

10. The battery cell according to claim 9, wherein a width W2 of the cap plate is greater than a width W1 of the opening.

11. The battery cell according to claim 9, wherein a thickness of the case body at regions other than the protrusion portion is equal to a thickness of the case body at the protrusion portion.

12. The battery cell according to claim 9, wherein the case body and the cap plate are sealed by welding.
